(19) United States
(12) Patent Application Publication
(10) Pub. No.: US 2012/0079275 A1
(43) Pub. Date: Mar. 29, 2012

(54) CONTENT FILTERING OF SECURE E-MAIL

(75) Inventor: Yeongtau Louis Tsao, Irvine, CA (US)

(73) Assignee: CANON KABUSHIKI KAISHA, Tokyo (JP)

(21) Appl. No.: 12/889,352

(22) Filed: Sep. 23, 2010

(51) Int. Cl. H04L 9/00; G06F 21/00; G06F 15/16

(52) U.S. Cl. 713/170; 709/206; 726/1

(57) ABSTRACT

Content filtering of e-mail in a network environment. The network environment includes a client machine, a policy server and an e-mail server. An e-mail message is authored at the client machine. Filter policy information is obtained by the client machine from the policy server, wherein the filter policy information defines a filtering policy for filtering of e-mail messages. The filter policy information is applied to the e-mail message by the client machine so as to effect the filtering policy. The filtered e-mail message is secured by the client machine, such as by securing based on a key obtained by the client machine from a key store. The secure e-mail message is sent by the client machine to a recipient via the e-mail server.

### FIELD

The present disclosure relates to email processed in accordance with a secure protocol such as S/MIME (Secure/Multipurpose Internet Mail Extensions), and more particularly relates to content filtering of secure e-mail.

### BACKGROUND

Conventional e-mail servers in enterprise e-mail environments typically support centralized content filtering of message content and attachment data. Such content filtering ordinarily includes the filtering of messages, such as to remove objectionable or confidential information, and the filtering of attachment data such as filtering based on file name, file name extension, and MIME content type. The e-mail server applies content filtering for all e-mail clients in the enterprise, thus effecting a centralized filtering.

To sign a message, a message sender uses the sender's private key (which is stored in a secure location) to encrypt a hash of the message, thereby to create a digital signature for the message. The sender then sends the message along with the digital signature as well as the sender's certificate (or a list of certificates for validating the validity of the certificate), which contains the sender's public key information. The recipient uses the received public key in the certificate to verify the message's digital signature.

To encrypt a message, a message sender obtains the recipient's public key, and uses the recipient's public key to encrypt the message. The sender then sends the encrypted message, along with the recipient's certificate, to a receiver. The recipient will use the recipient's private key (which is stored securely somewhere that the recipient can access) to decrypt the message.

Naturally, it is possible both to sign and to encrypt the same message.

Some secure e-mail exchange formats allow for creation and formatting of a signed-only message and an enveloped (encrypted)-only message. In addition, these formats specify that signing and encrypting operations can be applied in any order. For example, signing can be performed before encrypting to create a signed-first-then-encrypted (signed-and-encrypted) message. Also, encrypting can be performed before signing to create an encrypted-and-signed message.

### SUMMARY

It has been observed that conventional content filtering servers, e.g., enterprise-wide e-mail servers, ordinarily encounter difficulties when performing content filtering on secure e-mail messages.

In particular, if the content filtering server removes attachment data from a secure e-mail message having a secure e-mail exchange format, then the secure e-mail message might not be readable or validated by a recipient.

For example, in a case of an enveloped (encrypted)-only message, if the content filtering server removes attachment data, then the message might not be readable by a recipient. In a case of a signed-only message, if the content filtering server removes attachment data, then the recipient might not be able to validate that the received message is an original message sent from the sender because the data is altered after the digital signature value for the sender is created.

Moreover, conventional content filtering servers cannot ordinarily block specific content in the message content or the attachment data of an encrypted message without first decrypting an encrypted message. However, the server might not have access to the recipient's private key to decrypt the message.

Furthermore, if a content filtering server blocks specific content in the message content or the attachment data of a signed message, then the digital signature will become invalid. Although it might be possible to generate a new digital signature for the updated message using the sender's private key, the sender's private key might not be accessible after content filtering has been performed.

The foregoing situation is addressed through the application of a filtering policy by the same client machine that authors an e-mail message, wherein the client machine obtains the filtering policy from a policy server which is likewise accessible to other similarly-situated client machines, and where the client machine thereafter secures the filtered e-mail message.

Thus, in an example embodiment described herein, content filtering of e-mail is effected in a network environment which includes a client machine, a policy server and an e-mail server. An e-mail message is authored at the client machine. Filter policy information is obtained by the client machine from the policy server. The filter policy information obtained by the client machine defines a filtering policy for filtering of e-mail messages, such as a network-wide filtering policy also applicable to other client machines on the network. The filter policy information is applied to the e-mail message by the client machine, so as to effect the filtering policy. The filtered e-mail message is secured by the client machine, such as securing based on a key obtained by the client machine from a key store. The secure e-mail message is sent from the client machine to a recipient via the e-mail server.

In one advantage, content filtering can be performed for a secure e-mail message, while preserving the secure aspects of the e-mail.

In an example embodiment, the client machine secures the filtered e-mail message by signing the filtered e-mail message by using a private key of a sender of the e-mail message. In an example embodiment, the client machine secures the filtered e-mail message by encrypting the filtered e-mail message by using a public key of the recipient.

In an example embodiment, filtering of e-mail messages includes at least one of removing and updating specified message content of e-mail messages. In an example embodiment, filtering of e-mail messages includes removing specified attachment files from e-mail messages. In an example embodiment, filtering of e-mail messages includes at least one of removing and updating specified content in attachment files of e-mail messages. In an example embodiment, filtering of e-mail messages includes blocking an e-mail message, such that the e-mail message is not sent to specified recipients.

In an example embodiment, the policy server and the e-mail server are implemented on a common server machine. In an example embodiment, the policy server and the e-mail server are implemented on distinctly different machines that communicate over the network.

In an example embodiment, the filtering policy comprises a network-wide filtering policy which is applied by all of plural client machines on the network. In an example embodiment, the secure e-mail message is sent using an S/MIME (Secure/Multipurpose Internet Mail Extensions) protocol.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 is a representative view of an e-mail system relevant to one example embodiment.

FIG. 2 is a detailed block diagram showing the internal architecture of a computer.

FIG. 3 is a detailed block diagram depicting the internal architecture of the message sending device shown in FIG. 1.

FIG. 4 is a view for explaining an architecture for modules of the message sending device shown in FIG. 1.

FIG. 5 is a flow diagram for explaining content filtering of e-mail according to an example embodiment.

FIG. 6 is a flow diagram for explaining a process for sending an e-mail message according to an example embodiment.

FIG. 7 illustrates the structure and content of a MimeMessage according to an example embodiment

FIG. 8 is a view for explaining a sequence for sending an e-mail message according to an example embodiment.

### DETAILED DESCRIPTION

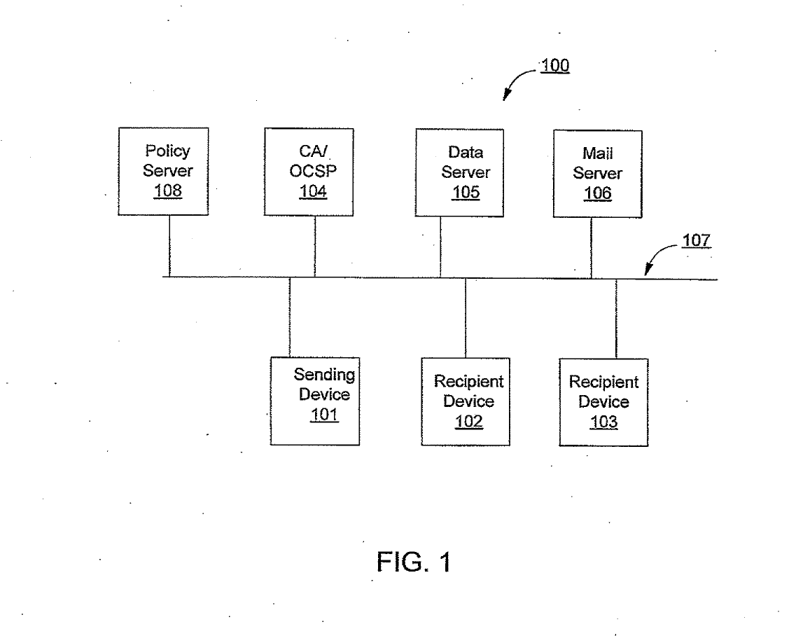

FIG. 1 is a representative view of an e-mail system relevant to one example embodiment. As shown in FIG. 1, e-mail system 100 includes sending device 101, recipient devices 102 and 103, data server 105, Certificate Authority (CA) and Online Certificate Status Protocol (OCSP) server 104, mail server 106, and policy server 108, which are all interconnected via network 107.

Mail server 106 is a computer that executes an e-mail server application, such as, for example, Microsoft Exchange Server, Sendmail e-mail server, or any other suitable type of e-mail server application.

Data server 105 is a computer that executes a data server application, such as, for example, a file server application, a web server application, a database server application, a media server application, or any other suitable type of data server application.

Network 107 is an intranet, but in other embodiments, network 107 can be the Internet, or any other suitable type of network for sending e-mail messages.

Certificate Authority (CA) and Online Certificate Status Protocol (OCSP) server 104 is a computer that executes a Certificate Authority server application and an OCSP server application.

Policy server 108 is a computer that executes a policy server application for providing filtering policy information for filtering of e-mail messages.

Sending device 101 is a device that executes an e-mail client application that authors (generates) and sends signed-and-encrypted e-mail messages having a signed-encrypted secure e-mail exchange format to recipient devices 102 and 103 via mail server 106. In other embodiments, the sending device can author any of a signed-only message, an enveloped (encrypted)-only message, and an encrypted-and-signed message.

In the example embodiment, the secure e-mail exchange format is an S/MIME format, however, in other embodiments, the secure e-mail exchange format can be any other suitable type of secure e-mail exchange format. In other embodiments, the sending device is also a recipient device that executes an e-mail client application that receives S/MIME e-mail messages from mail server 106. In the example embodiment, sending device 101 is a multi-function printer (MFP), but in other embodiments, sending device 101 can be any other type of device that sends e-mail messages, such as, for example, a computer, a scanner, a copy machine, a facsimile machine, a printer, a personal digital assistant (PDA), a mobile telephone, a handheld device, or the like.

Recipient devices 102 and 103 are devices that each executes an e-mail client application that receives S/MIME e-mail messages from mail server 106. In other embodiments, the recipient devices are also sending devices that execute an e-mail client application that generates and sends signed S/MIME e-mail messages to recipient devices via mail server 106.

In the example embodiment shown in FIG. 1, sending device 101, recipient devices 102 and 103, data server 105, Certificate Authority (CA) and Online Certificate Status Protocol (OCSP) server 104, mail server 106, and policy server 108 are shown to be separate devices. However, in other embodiments, many combinations of the functions of sending device 101, recipient devices 102 and 103, data server 105, Certificate Authority (CA) and Online Certificate Status Protocol (OCSP) server 104, mail server 106, and policy server 108 may be performed by one or more devices. For example, in other embodiments, an e-mail server application and a data server application may be executed by the same computer.

In the example embodiment shown in FIG. 1, sending device 101, recipient devices 102 and 103, data server 105, Certificate Authority (CA) and Online Certificate Status Protocol (OCSP) server 104, mail server 106, and policy server 108 are shown to be connected through one network. However, sending device 101, recipient devices 102 and 103, data server 105, Certificate Authority (CA) and Online Certificate Status Protocol (OCSP) server 104, mail server 106, and policy server 108 may be connected through more than one network, or through the Internet.

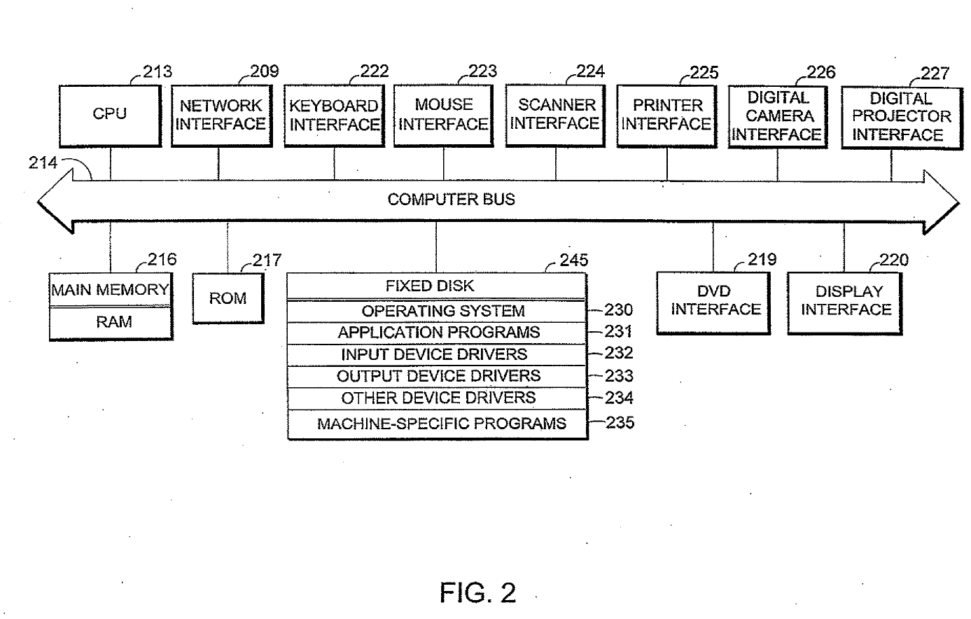

FIG. 2 is a detailed block diagram showing the internal architecture of a computer, such as any one of recipient devices 102 and 103, data server 105, Certificate Authority (CA) and Online Certificate Status Protocol (OCSP) server 104, mail server 106, and policy server 108. As shown in FIG. 2, the computer includes central processing unit (CPU) 213 which interfaces with computer bus 214. Also interfacing with computer bus 214 are hard disk 245, network interface 209, random access memory (RAM) 216 for use as a main run-time transient memory, read only memory (ROM) 217, DVD disk interface 219, display interface 220 for a monitor, keyboard interface 222 for a keyboard, mouse interface 223 for a pointing device, scanner interface 224 for a scanner, printer interface 225 for a printer, digital camera interface 226 for a digital camera, and digital projector interface 227 for a digital projector.

RAM 216 interfaces with computer bus 214 so as to provide information stored in RAM 216 to CPU 213 during execution of the machine-executable instructions in software programs such as an operating system, application programs, and device drivers. More specifically, CPU 213 first loads computer-executable process steps (encoded in machine-executable instructions) from fixed disk 245, or another storage device into a region of RAM 216. CPU 213 can then execute the stored process steps from RAM 216 in order to execute the loaded computer-executable process steps. Data such as color images or other information can be stored in RAM 216, so that the data can be accessed by CPU 213 during the execution of computer-executable software programs (encoded in machine-executable instructions), to the extent that such software programs have a need to access and/or modify the data.

As also shown in FIG. 2, hard disk 245 stores operating system 230, and application programs 231 (encoded in machine-executable instructions), such as e-mail server applications, file server applications, web server applications, database server applications, media server application, Certificate Authority server applications, OCSP server applications, policy server applications, and e-mail client applications. Hard disk 245 also contains device drivers for software interface to devices, such as input device drivers 232, output device drivers 233, and other device drivers 234.

Hard disk 245 further stores machine-specific programs 235, as appropriate to the nature and role of the machine, as discussed more fully below. For example, in the case of sending device 101, the machine-specific programs 235 may include an email authoring program in accordance with a secure protocol, and in the case of policy server 108, machine-specific instructions 235 may include a network program responsive to requests from client machines for a current version of an enterprise-wide email filtering policy.

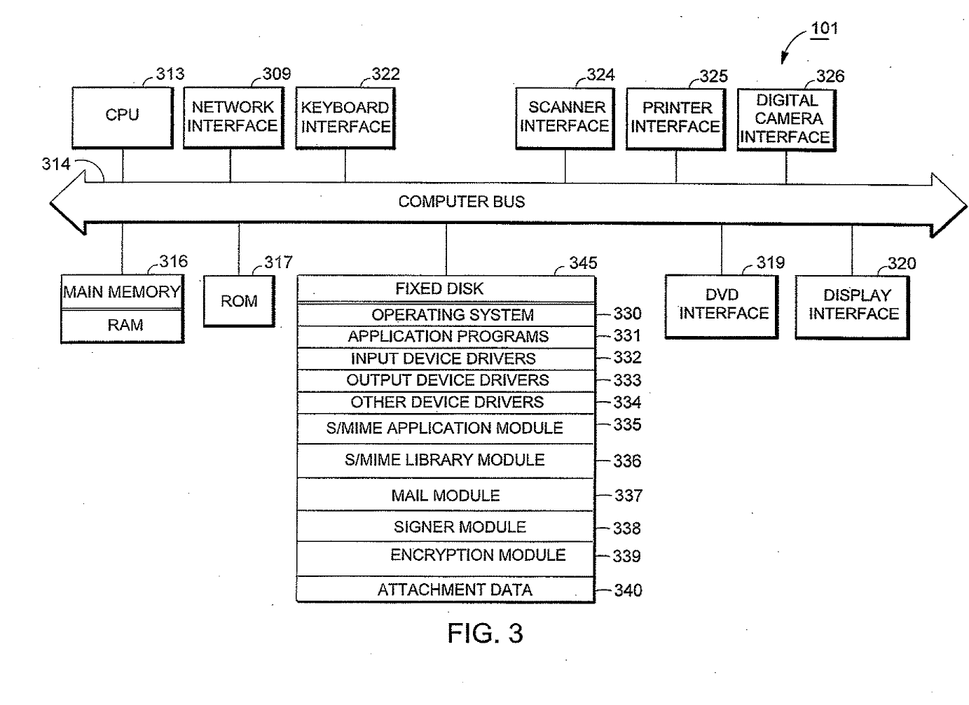

FIG. 3 is a detailed block diagram showing the internal architecture of sending device 101. As shown in FIG. 3, sending device 101 includes central processing unit (CPU) 313 which interfaces with computer bus 314. Also interfacing with computer bus 314 are hard disk 345, network interface 309, random access memory (RAM) 316 for use as a main run-time transient memory, read only memory (ROM) 317, DVD disk interface 319, display interface 320 for a display, keyboard interface 322 for a keyboard, scanner interface 324 for a scanner, printer interface 325 for a printer, and digital camera interface 326 for a digital camera.

RAM 316 interfaces with computer bus 314 so as to provide information stored in RAM 316 to CPU 313 during execution of the machine-executable instructions in software programs such as an operating system, application programs, and device drivers. More specifically, CPU 313 first loads computer-executable process steps (encoded in machine-executable instructions) from fixed disk 345, or another storage device into a region of RAM 316. CPU 313 can then execute the stored process steps from RAM 316 in order to execute the loaded computer-executable process steps. Data such as confidential and non-confidential documents or other information can be stored in RAM 316, so that the data can be accessed by CPU 313 during the execution of computer-executable software programs (encoded in machine-executable instructions), to the extent that such software programs have a need to access and/or modify the data.

As also shown in FIG. 3, hard disk 345 contains operating system 330, application programs 331 (encoded in machine-executable instructions). Hard disk 345 also contains device drivers for software interface to devices, such as input device drivers 332, output device drivers 333, and other device drivers 334. Hard disk 345 also contains S/MIME application module 335, S/MIME library module 336, mail module 337, signer module 338, and encryption module 339.

S/MIME application module 335 comprises computer-executable process steps (encoded in machine-executable instructions) for an e-mail client application that authors an e-mail message at sending device 101 and sends secure email such as email signed and encrypted according to an S/MIME protocol by calling S/MIME library module 336. In other embodiments, S/MIME application module 335 comprises computer-executable process steps (encoded in machine-executable instructions) for an e-mail client application that authors an e-mail message at sending device 101 and sends signed-only, encrypted-only, and/or encrypted-and-signed S/MIME e-mail messages.

S/MIME library module 336 comprises computer-executable process steps (encoded in machine-executable instructions) executed by CPU 313 for content filtering of secure e-mail in a network environment.

S/MIME library module 336 generally comprises computer-executable process steps (encoded in machine-executable instructions) that receive an e-mail message authored by sending device 101, and obtain filter policy information from policy server 108, via S/MIME application module 335. The filter policy information is obtained by sending device 101 and defines a filtering policy for filtering of e-mail messages. The process steps of S/MIME library module 336 apply the filter policy information to the e-mail message. The filter policy information is applied by sending device 101 to the e-mail message so as to effect the filtering policy. The process steps of S/MIME library module 336 secure the filtered e-mail message. The filtered e-mail message is secured by sending device 101 based on a key obtained by sending device 101 from a key store. The process steps of S/MIME library module 336 send the secure e-mail message to a recipient, such as, for example, recipient devices 102 and 103, via the e-mail server 106. In the example embodiment, e-mail messages are secured by signing and then encrypting e-mail messages. In other embodiments, e-mail messages are secured by signing only, by encrypting only, and/or by encrypting and then signing.

In the example embodiment, signer module 338 comprises computer-executable process steps (encoded in machine-executable instructions) for a Cryptograph hash algorithm, such as, for example, an MD5 (Message-Digest algorithm 5) digest algorithm. However, in other embodiments, signer module 338 can comprise computer-executable process steps (encoded in machine-executable instructions) for a Secure Hash Algorithm (SHA)-1 digest algorithm, and instructions for an SHA-2 family algorithm (e.g., an SHA-224 digest algorithm, an SHA-256 digest algorithm, an SHA-384 digest algorithm, and an SHA-512 digest algorithm). Signer module 338 also contains the signer information that specifies the signer's private key. Signer module 338 calculates a digest value by using the Cryptograph hash algorithm, and uses the calculated digest value and the signer's private key to generate PKCS7 digital signature data for S/MIME signature. The generated PKCS7 digital signature data is used to generate a PKCS7 signed message having either an “application/pkcs7-mime” MIME type or “an application/pkcs7-signature” MIME type. An encrypted or opaque-signed PKCS7 signed message has an “application/pkcs7-mime” MIME type, and a clear-signed PKCS7 signed message has an “application/pkcs7-signature” MIME type.

Mail module 337 comprises computer-executable process steps (encoded in machine-executable instructions) executed by CPU 313 for supporting e-mail client functionality.

Encryption module 339 comprises computer-executable process steps (encoded in machine-executable instructions) for a symmetric-key encryption algorithm, such as, for example, a Triple DES (Data Encryption Standard) encryption algorithm. However, in other embodiments, encryption module 339 comprises computer-executable process steps (encoded in machine-executable instructions) for an AES (Advanced Encryption Standard) encryption algorithm, such as, for example, an AES-128, AES-192, or AES-256 algorithm. Encryption module 339 also contains recipient information that specifies the recipient's public key. In the example embodiment, the recipient's public key is included in a recipient certificate. The recipient's public key is used to generate a PKCS7 encrypted message having an “application/pkcs7-mime” MIME type, and having PKCS7 encryption data for S/MIME encryption.

In the example embodiment, attachment data 340 refers to data stored on remote locations, such as, for example, locations on data server 105. In other embodiments, attachment data 340 can refer to data stored locally on hard disk 345, or addresses of real-time input devices, such as, for example, a scanner connected to scanner interface 324.

In example embodiments, attachment data 340 might not exist before a MimeMessage object is generated, such as, for example, in a case where attachment data 340 relates to data generated by a real-time input device. In a case where attachment data 340 does not exist before the MimeMessage object is generated, a streaming module calls an I/O thread to get a pointer to an input data stream for attachment file locations contained in an attachment MimeBodyPart object of the MimeMessage object.

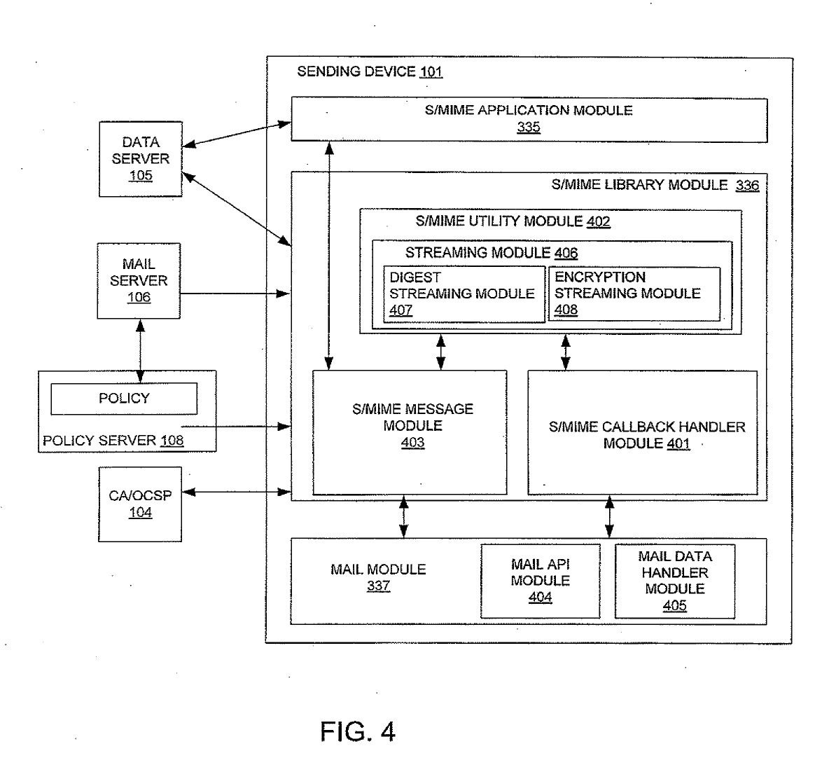

FIG. 4 is a view for explaining an architecture for modules of sending device 101. As shown in FIG. 4, sending device 101 includes S/MIME application module 335, S/MIME library module 336, and mail module 337.

S/MIME application module 335 is an e-mail client application that authors and sends signed-and-encrypted S/MIME e-mail messages by calling S/MIME library module 336 to generate and send an S/MIME message using mail module 337.

In the example embodiment, mail module 337 is a platform and protocol independent mail module. In particular, mail module 337 includes mail API module 404 for packaging and sending e-mail messages and mail data handler module 405 for handling content and attachment data included in e-mail messages.

In the example embodiment, mail API module 404 provides a set of abstract classes and interfaces for supporting e-mail client functionality. An example mail API module is the JavaMail API, which is described in “JavaMail™ API Design Specification”, Version 1.4, Sun Microsystems Inc., December 2005, and “JavaMail™ Guide for Service Providers”, Revision 01, Sun Microsystems Inc., August 1998, and “JavaMail API documentation”, JavaMail 1.3.3, Jun. 27, 2003, available at <http http://java.sun.com/products/javamail/javamail-1_{—}3_{—}1.html>, Sun Microsystems Inc., the entire contents of which are incorporated by reference as if set forth in full herein.

Mail API module 404 defines, for example, classes for MimeMessage, MimeMultipart, MimeBodyPart, and Transport MIME objects. The MimeMessage and MimeBodyPart classes implement widely used Internet mail protocols and conform to specifications RFC 822, “Standard for ARPA Internet Text Messages”, dated August 1982 (which obsoletes RFC 733), and RFC 2045, “Multipurpose Internet Mail Extensions (MIME) Part One: Format of Internet Message Bodies”, dated November 1996 (which obsoletes RFC 1521, 1522, and 1590), the entire contents of which are incorporated by reference as if set forth in full herein.

The MimeMessage class defines a set of attributes and a content for a mail message. Attributes of the MimeMessage class specify addressing information and define the structure of the content, including the content type. The content of a MimeMessage object for a typical multipart mime message is represented as a MimeMultipart object that includes one or more MimeBodyPart objects. The content of each MimeBodyPart is represented as a DataHandler object that wraps around the actual data.

The MimeMessage class adds From, To, Subject, Reply-To, and other attributes necessary for message routing via a message transport system. The content of a message is a collection of bytes, or a reference to a collection of bytes, encapsulated within a MimeMessage object.

The MimeMultipart class is an implementation of the abstract Multipart class that uses MIME conventions for the multipart data. MimiMultipart objects contain one or more MimeBodypart objects.

Mail API module 404 ordinarily has no knowledge of the data type or format of the message content. A MimeMessage object interacts with its content through an intermediate layer, mail data handler module 405. This separation allows a MimeMessage object to handle any arbitrary content and to transmit it using any appropriate transmission protocol by using calls to the same API methods.

An example mail data handler module is the JavaBeans Activation Framework, which is described in Calder, et. al, “JavaBeans™ Activation Framework Specification”, Version 1.0a, Sun Microsystems Inc., May 27, 1999, and JavaBeans Activation Framework 1.0.2 API documentation, 2002, available at <http http://http://java.sun.com/products/archive/javabeans/jaf102.html>, Sun Microsystems Inc., the entire contents of which are incorporated by reference as if set forth in full herein.

Mail data handler module 405 defines the DataHandler class for a DataHandler object, FileDataSource class for a FileDataSource object, and URLDataSource class for a URLDataSource object. In the example embodiment, the DataHandler object is a general data handler for accessing data, the FileDataSource class is a data handler for accessing data identified by a file, and the URLDataSource class is a data handler for accessing data identified by a Uniform Resource Locator (URL).

Mail API module 404 provides methods to interact with mail data handler module 405. Mail API module 404 also provides methods to interact with customized class libraries. For example, the MimeMessage sclass defines a setDataHandler( ) method that specifies a customized DataHandler class to be used for accessing content of a MimeMessage.

Support for secure messaging (e.g., support for S/MIME) is not ordinarily provided by mail module 337. Accordingly, in the example embodiment, S/MIME library module 336 is provided, which is a library module that builds security on top of MIME to provide secure electronic messaging of Internet mail in the form of message authentication and data security.

S/MIME library module 336 includes S/MIME callback handler module 401, S/MIME utility module 402, and S/MIME message module 403. S/MIME utility module 402 includes streaming module 406. Streaming module 406 includes digest streaming module 407, and encryption streaming module 408.

S/MIME callback handler module 401 receives a callback from mail module 337, and processes a MIMEMultipart object which includes a MimeBodyPart object for message content, a MimeBodyPart object for attachment data, and a MimeBodyPart object for MIME PKCS7 signature data.

Streaming module 406 receives a callback from S/MIME callback handler module 401 for streaming and digesting attachment data. Digest streaming module 407 receives a callback from S/MIME callback handler module 401 for generating MIME PKCS7 signature data having either an “application/pkcs7-mime” MIME type or an “application/pkcs7-signature” MIME type.

Methods in S/MIME library module 336 are called by S/MIME application module 335 and interact with mail module 337, and S/MIME library module 336 calls methods in mail module 337. S/MIME library module 336 validates a certificate's validity with CA/OCSP server 104, and streams attachment data from a data source (e.g., local storage locations on hard disk 345, addresses of real-time data input devices, such as, for example, a scanner connected to scanner interface 324, or remote locations, such as, for example, locations on data server 105). S/MIME application module 335 can control the streaming of attachment data from the data source to S/MIME library module 336. S/MIME library module 336 streams attachment data and a digital signature to mail server 106.

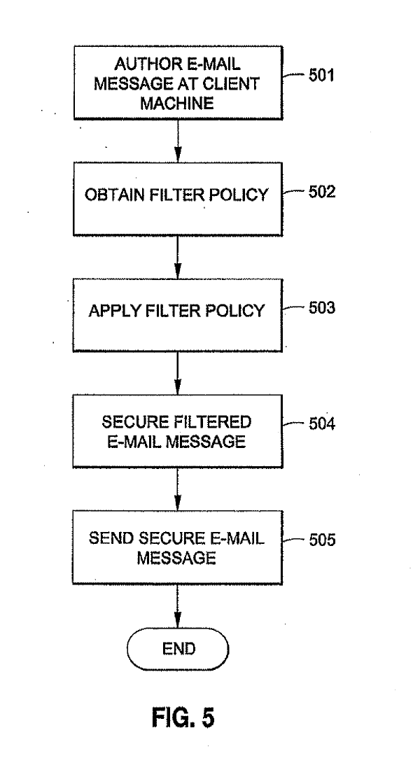

FIG. 5 is a flow diagram for explaining content filtering of e-mail according to an example embodiment.

Briefly, according to FIG. 5, content filtering of e-mail is effected in a network environment which includes a client machine, a policy server and an e-mail server.

In step 501, an e-mail message is authored at the client machine. In step 502, filter policy information is obtained by the client machine from the policy server. The filter policy information obtained by the client machine defines a filtering policy for filtering of e-mail messages, such as a network-wide filtering policy also applicable to other client machines on the network. In step 503, the filter policy information is applied to the e-mail message by the client machine, so as to effect the filtering policy. In step 504, the filtered e-mail message is secured by the client machine, such as securing based on a key obtained by the client machine from a key store. In step 505, the secure e-mail message is sent from the client machine to a recipient via the e-mail server.

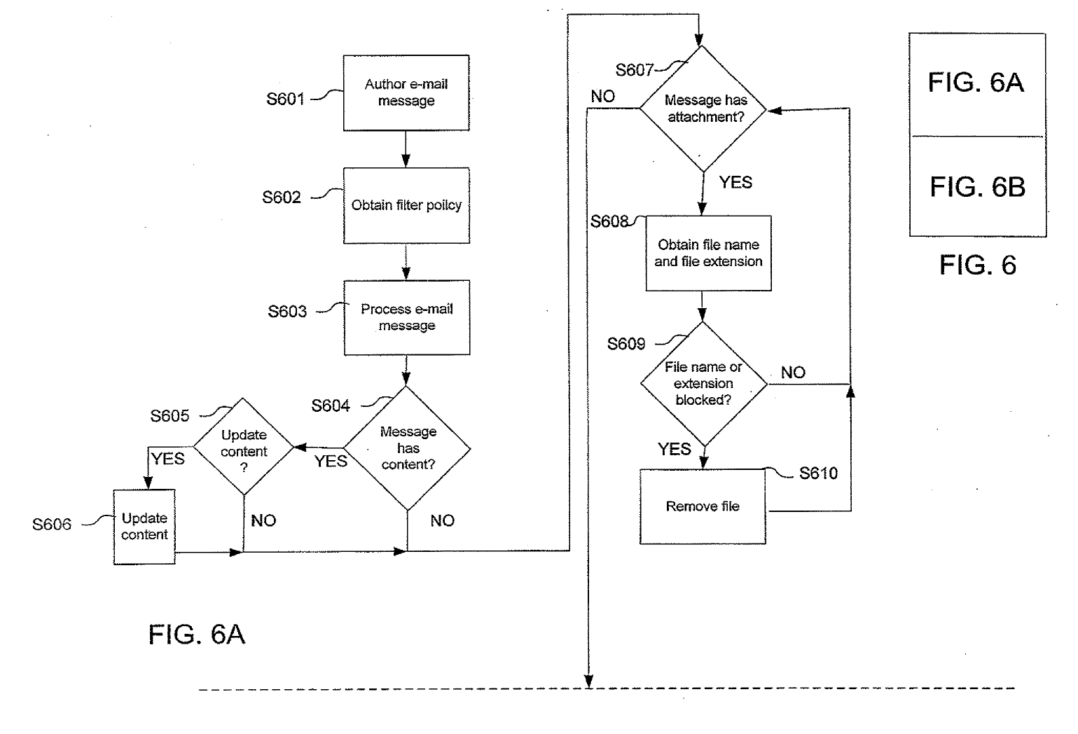

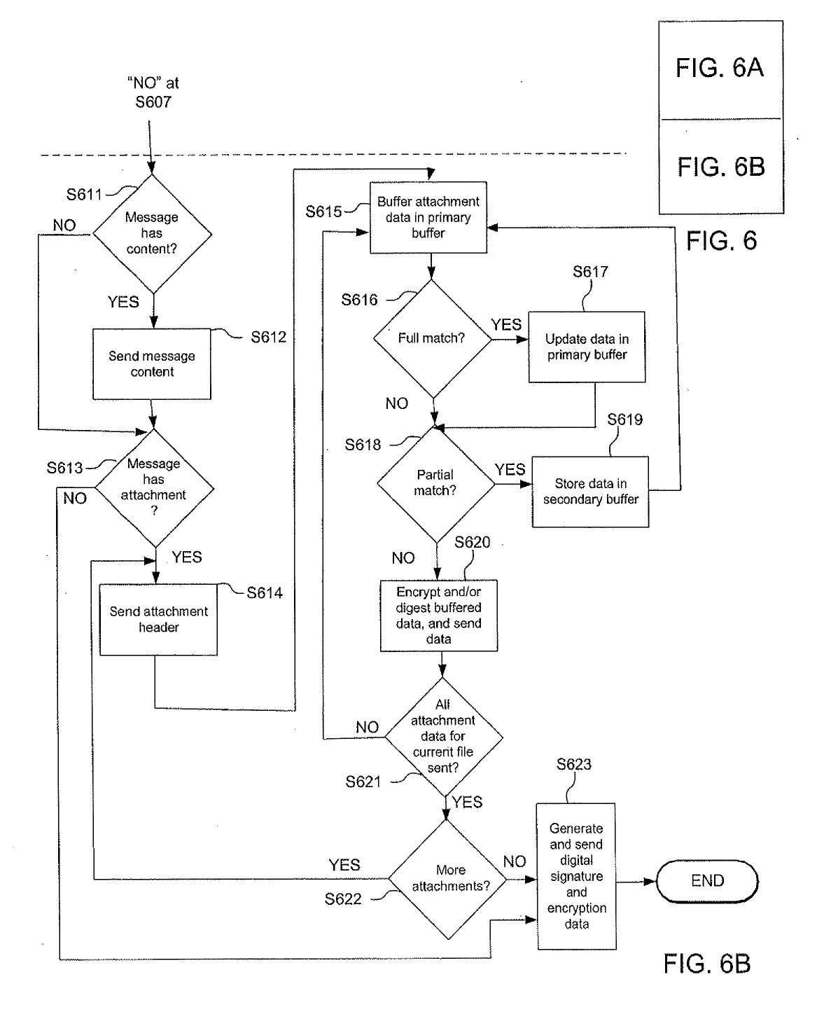

The process of FIG. 5 will now be described in more detail with respect to FIG. 6. FIG. 6 is a flow diagram for explaining a process for sending an e-mail message using sending device 101.

At step S601, S/MIME application module 335 authors an e-mail message at sending device 101 and calls a method in S/MIME message module 403 (which is part of the S/MIME library module 336) to generate a signed-and-encrypted S/MIME e-mail message. S/MIME application module 335 calls a method in S/MIME message module 403 to pass transport information (which includes smtpHost, from, subject, and content information) to create a an SMIMEMail object. S/MIME application module 335 sets signer information. In the example embodiment, signer information can specify a certificate store that contains the signer's private key used to generate the MIME PKCS7 signature data, a signer's private key and a signer certificate or certificate list, a reference to an interface for a smart card or an application module that generates the MIME PKCS7 signature data using the signer's private key, or a reference to an interface for a smart card or an application module that generates the MIME PKCS7 signature data using the signer's private key along with a signer certificate list.

S/MIME application module 335 sets the recipient information of the SMIMEMail object to specify a list of all recipients. In the example embodiment, for each recipient, the recipient information can specify a certificate store that contains the recipient's public key used to encrypt the message, the recipient's public key and a recipient certificate or certificate list, a reference to an interface for a smart card or an application module that encrypts the message using the symmetric-key encryption algorithm along with the recipient's public key, or a reference to an interface for a smart card or an application module that encrypts the message using the symmetric-key encryption algorithm along with a recipient certificate that contains the recipient's public key.

S/MIME application module 335 sets attachment information of the SMIMEMail object to specify one or more locations of attachment data. S/MIME application module 335 updates and verifies the signer information, recipient information, and/or attachment information, if any of the signer information, recipient information, and/or attachment information is invalid. S/MIME application module 335 packages the signer information, recipient information, and attachment information (specified by the SMIMEMail object) into a MimeMessage object.

In particular, S/MIME message module 403 validates the signer certificate specified by the signer information of the SMIMEMail object by validating a certificate list (i.e., certificate chain) for the signer certificate. If the signer information does not specify a signer certificate list for the signer certificate, S/MIME message module 403 validates the signer certificate by building a certificate chain for the signer certificate, and validating the certificate chain.

If a configuration setting specifies that Certificate Revocation List (CRL) chain validation is to be performed, S/MIME message module 403 builds a CRL chain for the signer certificate, and validates the CRL chain. If a configuration setting specifies that Online Certificate Status Protocol (OCSP) validation is to be performed, S/MIME message module 403 validates the signer certificate using OCSP. If a configuration setting specifies that both CRL chain validation and OCSP validation are to be performed, S/MIME message module 403 first performs OCSP validation, and then performs CRL chain validation if OCSP validation cannot be performed, or if problems are encountered.

In another embodiment, a CRL chain is sent to recipients which perform CRL validation of the signer certificate.

If the signer certificate is valid, S/MIME message module 403 creates a MimeBodyPart object for message content, a MimeBodyPart object for attachment data, and a MimeBodyPart object for MIME PKCS7 signature data, and sets the appropriate message header attributes. The attachment MimeBodyPart content contains the location of attachment files included in the attachment information, and digest algorithm information specified by the signer information. These file locations can include local storage locations on hard disk 345, addresses of real-time data input devices, such as, for example, a scanner connected to scanner interface 324, or remote locations, such as, for example, locations on data server 105. The attachment files can have any type of format, such as, for example, .pdf, .tiff, .img, .doc, .zip format, or any other type of data format. The MIME PKCS7 signature MimeBodyPart content contains the signer information. S/MIME message module 403 adds the attachment MimeBodyPart and the MIME PKCS7 signature MimeBodyPart to a MimeMultipart object, and includes the MimeMultipart object in the content of the MimeMessage object.

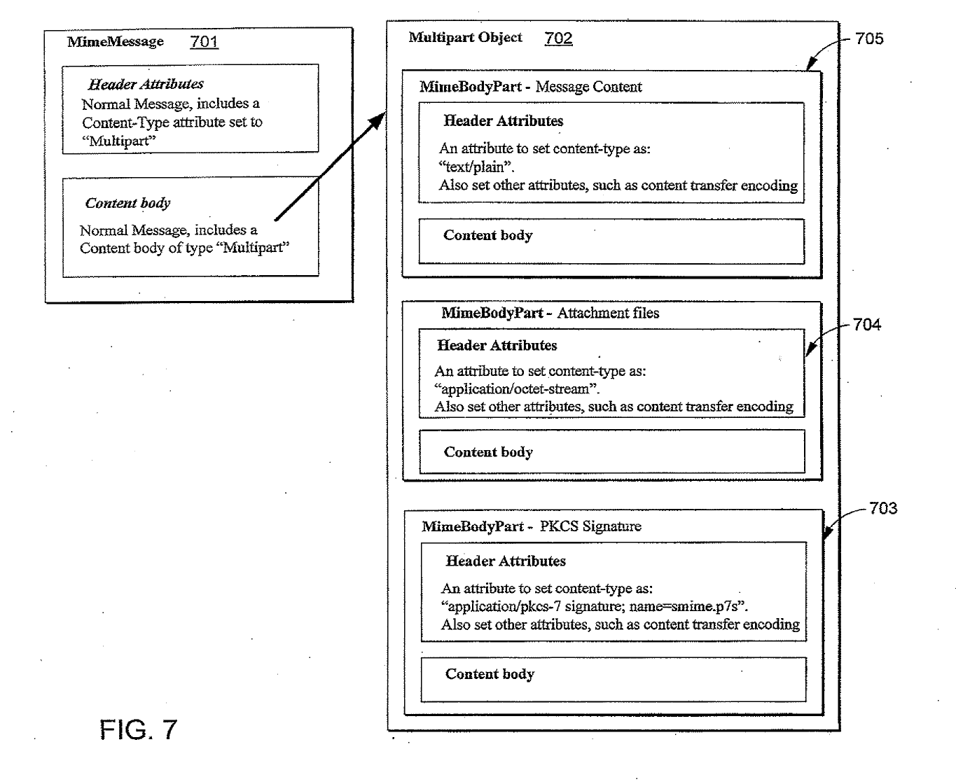

FIG. 7 illustrates the structure and content of a MimeMessage according to an example embodiment. As shown in FIG. 7, MimeMessage 701 is a message object where the Content-Type is set to “multipart”, and the Content Body carries a reference to MimeMultipart object 702. MimeMultipart object 702 is a container of three MimeBodyPart objects, where message content Mime BodyPart 705 contains message content, attachment files MimeBodyPart 704 contains attachment information, and PKCS Signature MimeBodyPart 703 contains signer information.

Returning to FIG. 6, and continuing with the explanation of authoring an email message at step S601, S/MIME message module 403 calls a method (e.g., sendMessage( )) to register S/MIME callback handler module 401 as the callback class for the MimeMessage object.

S/MIME message module 403 returns the packaged MimeMessage object to S/MIME application module 335. After receiving the packaged MimeMessage, S/MIME application module 335 updates message headers of the MimeMessage object if it is determined that the message headers of the MimeMessage object are to be updated.

S/MIME application module 335 calls a method of the SMIMEMail object to send the e-mail message represented by the received MimeMessage.

Before the e-mail message represented by the received MimeMessage is sent, the attachment MimeBodyPart of the MimeMessage object does not contain the actual attachment data, but rather contains the location of attachment files. As the e-mail message is being sent, attachment data is streamed from the file locations. Because S/MIME message module 403 performs certificate validation before the attachment data is streamed from the file locations, certificate validation errors can be detected and handled before the attachment data streaming operation is performed, without interrupting the streaming operation.

In other embodiments, certificate validation is not performed before attachment data is streamed. In further embodiments, certificate validation is not performed.

Similarly, before the e-mail message represented by the received MimeMessage is sent, the MIME PKCS7 signature MimeBodyPart of the MimeMessage object does not contain the actual MIME PKCS7 signature data, but rather contains the signer information which specifies the signer used to generate the MIME PKCS7 signature data.

Attachment data is digested as it is being streamed from the file locations and sent to mail server 106.

At step S602, S/MIME library module 336 obtains filter policy information. In the example embodiment, S/MIME library module 336 obtains filter policy information from at least one of the policy server 108, the mail server 106, and S/MIME application module 335. The filter policy information defines a filtering policy for filtering of e-mail messages.

At step S603, the e-mail message represented by the received MimeMessage is processed by generating streams for streaming the e-mail message to a mail server, and by sending header attributes of the e-mail message to the mail server via the generated streams.

In particular, mail API module 404 (which is included in mail module 337) generates output data streams for streaming the e-mail message represented by the MimeMessage object from sending device 101 to a mail server specified by the recipient information (e.g., mail server 106), and connected to sending device 101 via network 107. The mail API module 404 generates the output data streams by using mail data handler module 405, which is also included in mail module 337. More precisely, the mail API module 404 uses the mail data handler module 405 to generate an output data stream that wraps a signing output data stream and an encryption output data stream. The output data stream is represented by streaming module 406, the signing output data stream is represented by digest streaming module 407, and the encryption output data stream is represented by encryption streaming module 408, as shown in FIG. 4. The signing output data stream is based on the signer information and the Cryptograph hash algorithm used to sign the e-mail message. The encryption output data stream is based on the symmetric-key encryption algorithm and the recipients' certificates, as identified by the recipient information specified in the Mime Message.

After generating the signing output data stream and the encryption output data stream, which are embedded in streaming module 406, mail API module 404 calls S/MIME callback handler module 401 (which is registered as the callback class for the MimeMessage object) via mail data handler module 405, and passes a pointer to the streaming module 406 to S/MIME callback handler module 401. In response to receiving the callback from mail API module 404, S/MIME callback handler module 401 sends the header attributes of the MimeMessage object to the mail server via the streaming module 406.

In steps S604 to S609 and S614 to S621, the filter policy obtained at step S602 is applied to the email message.

More precisely, at step S604, S/MIME library module 336 determines whether the MimeMessage has content. In the example embodiment, the MimeMessage object includes a MimeMultipart object that includes plural MimeBodyPart objects. In the example embodiment, message content is included in the first MimeBodyPart object, and S/MIME callback handler module 401 retrieves the first MimeBodyPart object from the MimeMultipart object of the MimeMessage object to determine if the Mime Message includes message content. In other embodiments, the message content is included in a MimeBodyPart other than the first MimeBodyPart.

If the MimeMessage includes message content (“YES” at step S604), then at step S605, S/MIME library module 336 determines whether the message content should be updated, based on the filter policy information obtained at step S602. In the example embodiment, the message content is updated if text strings corresponding to the message content match text strings specified by the obtained policy information.

If S/MIME library module 336 determines that the message content should not be updated (“NO” at step S605), then processing proceeds to step S607.

If S/MIME library module 336 determines that the message content should be updated (“YES” at step S605), then processing proceeds to step S606, where the message content is updated. In the example embodiment, matching text strings are removed from the message content. In other embodiments, matching text strings are replaced with replacement text strings specified by the obtained filter policy information. In other embodiments, the MimeMessage is abandoned if it is determined that text strings corresponding to the message content match text strings specified by the obtained policy information. Thereafter, processing proceeds to step S607.

If the MimeMessage does not include message content (“NO” at step S604), then at step S607, S/MIME library module 336 determines whether the MimeMessage has attachment data. In an example embodiment, it is determined that the MimeMessage has attachment data if the MimeMessage object includes a MimeBodyPart object that has a DataHandler object. In the example embodiment, the DataHandler object specifies a full file path of an attachment file corresponding to the attachment data.

If S/MIME library module 336 determines that the MimeMessage does not have attachment data (“NO” at step S607), then processing proceeds to step S611.

If S/MIME library module 336 determines that the MimeMessage has attachment data (“YES” at step S607), then at step S608, S/MIME library module 336 obtains the filename and file extension of the attachment file corresponding to the attachment data. Thereafter, processing proceeds to step S609.

At step S609, S/MIME library module 336 determines whether the filename and/or file extension of the attachment file corresponding to the attachment data is blocked, based on the policy obtained at step S602.

If S/MIME library module 336 determines that the filename and/or file extension of the attachment file corresponding to the attachment data is blocked, then at block S610, S/MIME library module 336 removes the attachment file. In the example embodiment, the attachment file is removed by accessing the MimeMultiPart object of the MimeMessage, identifying the MimeBodyPart object included in the MimeMultiPart object that corresponds to the attachment file and removing the identified MimeBodyPart object from the MimeMultiPart object. After the attachment file is removed, processing returns to step S607, where S/MIME library module 336 determines whether there are any more attachments.

In another embodiment, the MimeMessage is abandoned if it is determined that the filename and/or file extension of the attachment file corresponding to the attachment data is blocked.

In another embodiment, information is added to the MimeMessage indicating that the attachment file has been removed. In another embodiment, a separate e-mail is sent to each recipient to inform each recipient that the attachment file has been removed.

At step S611, S/MIME library module 336 determines whether the MimeMessage includes message content. If the MimeMessage does not include message content, (“NO” at step S611), then processing proceeds to step S613.

If the MimeMessage includes message content, (“YES” at step S611), then at step S612, S/MIME library module 336 sends the message content header attributes to the mail server via the output data stream, and then sends the message content to the mail server via the output data stream. Also, for the message content (as opposed to the message content header), S/MIME library module 336 applies the encryption output data stream to the message content if the message content is to be encrypted, and applies the signing output data stream to the message content if the message content is to be signed. For an encrypted and then signed message, S/MIME library module 336 first applies the encryption output data stream to the message content, and then applies the signing output data stream to the encrypted message content. For a signed and then encrypted message, S/MIME library module 336 first applies the signing output data stream to the message content, and then applies the encryption output data stream to the signed message content. Thereafter, processing proceeds to step S613.

At step S613, S/MIME library module 336 determines whether the MimeMessage includes attachment data. If the MimeMessage does not include attachment data, (“NO” at step S613), then processing ends.

If the MimeMessage does not include attachment data, (“NO” at step S613), then processing proceeds to step S623.

If the MimeMessage includes attachment data, (“YES” at step S613), then at step S614, S/MIME library module 336 sends attachment data header attributes for the first attachment data to the mail server via the streaming module 406.

After sending the attachment data header attributes, S/MIME callback handler module 401 prepares to send the attachment data content by calling streaming module 406. After receiving the call from S/MIME callback handler module 401, streaming module 406 gets a pointer to an input data stream for the attachment file locations corresponding to the attachment data. In the example embodiment, the attachment file locations are specified in an attachment MimeBodyPart object of the MimeMessage object. Streaming module 406 sends the input data stream pointer to S/MIME callback handler module 401. After receiving the input data stream pointer, S/MIME callback handler module 401 uses the streaming method to read the attachment data via the input data stream, and pass the streamed attachment data to streaming module 406, via S/MIME callback handler module 401. In response to receiving the call from S/MIME callback handler module 401, mail API module 404 reads the attachment data from the input data stream, and calls streaming module 406. In response, streaming module 406 receives data from the specified data source.

At step S615, streaming module 406 receives streamed attachment data from the specified data source location, and buffers the received attachment data in a primary buffer memory (e.g., RAM 316). The primary buffer memory is used to buffer the data for content filtering. The primary buffer memory is also used to improve system performance by sending data after buffering a specified number of bytes from the specified data source location, as opposed to sending each byte, or a small number of bytes, as it is read from the specified data source location.

In another example embodiment, the attachment data is read by S/MIME application module 335. In particular, S/MIME application module 335 implements an I/O thread for receiving a callback from S/MIME library module 336, which provides S/MIME application module 335 with a pointer to an input data stream for the attachment file locations corresponding to the attachment data. S/MIME application module 335 reads the attachment data via the input data stream, and buffers the received attachment data in the primary buffer memory of streaming module 406.

After a predetermined number of bytes of attachment data is buffered in the primary buffer memory, processing proceeds to step S616.

At step S616, S/MIME library module 336 determines whether there is a full match between text strings corresponding to the buffered attachment data and text strings specified by the obtained policy information.

If S/MIME library module 336 determines that there is a full match (“YES at step S616”), then processing proceeds to step S617, where the buffered attachment data is updated. Thereafter, processing proceeds to step S618.

In the example embodiment, matching text strings are removed from the buffered attachment data. In other embodiments, matching text strings are replaced with replacement text strings specified by the obtained filter policy information. In other embodiments, the MimeMessage is abandoned if it is determined that text strings corresponding to the attachment data match text strings specified by the obtained policy information.

In the example embodiment, a full match is determined by converting the buffered attachment data into binary data, acquiring binary data corresponding to the text strings specified by the obtained policy information, and comparing the binary data for the buffered attachment data with the binary data for the specified text strings.

In another example embodiment, the obtained policy information identifies an application type (e.g., Word, Excel, PDF, HTML, ASCII, and the like) associated with each text string specified in the obtained policy information. To determine a full match, the application type of the binary attachment data is obtained, and the application type of the binary attachment data is compared with the application types of the text strings specified in the policy information. If the application types match, then the binary data for the buffered attachment data is compared with the binary data for the specified text strings to determine a full match.

In another example embodiment, the obtained policy information identifies both an application type (e.g., Word, Excel, PDF, HTML, ASCII, and the like) and an application version associated with each text string specified in the obtained policy information. To determine a full match, the application type and application version of the binary attachment data is obtained, and the application type and the application version of the binary attachment data is compared with the application types and application versions of the text strings specified in the policy information. If the application types and the application versions match, then the binary data for the buffered attachment data is compared with the binary data for the specified text strings to determine a full match.

In the example embodiment, when determining a full match, S/MIME library module 336 determines whether a secondary buffer memory, used for storing partially matched data, is empty. If the secondary buffer memory is not empty, then S/MIME library module 336 appends the attachment data in the primary buffer memory to the end of the data in the secondary buffer memory to form aggregated attachment data. S/MIME library module 336 determines a full match between text strings corresponding to the aggregated attachment data and text strings specified by the obtained policy information. In response to a determination that there is a full match, S/MIME library module 336 updates buffered attachment data in the primary buffer memory and updates buffered attachment data in the secondary buffer memory.

If S/MIME library module 336 determines that there is not a full match (“NO at step S616”), then processing proceeds to step S618.

At step S618, S/MIME library module 336 determines whether there is a partial match between text strings corresponding to the buffered attachment data and text strings specified by the obtained policy information.

If S/MIME library module 336 determines that there is a partial match (“YES at step S618”), then processing proceeds to step S619, where the buffered attachment data is stored in the secondary buffer memory. Thereafter, processing returns to step S615, where streaming module 406 receives another portion of streamed attachment data from the specified data source location, and buffers the received attachment data in the primary buffer memory.

In the example embodiment, a partial match is determined by converting the buffered attachment data, stored in the primary buffer memory, into binary data, acquiring binary data corresponding to the text strings specified by the obtained policy information, and comparing the binary data for the buffered attachment data with the binary data for the specified text strings.

In another example embodiment, the obtained policy information identifies an application type (e.g., Word, Excel, PDF, HTML, ASCII, and the like) associated with each text string specified in the obtained policy information. To determine a partial match, the application type of the binary attachment data is obtained, and the application type of the binary attachment data is compared with the application types of the text strings specified in the policy information. If the application types match, then the binary data for the buffered attachment data is compared with the binary data for the specified text strings to determine a partial match.

In another example embodiment, the obtained policy information identifies both an application type (e.g., Word, Excel, PDF, HTML, ASCII, and the like) and an application version associated with each text string specified in the obtained policy information. To determine a partial match, the application type and application version of the binary attachment data is obtained, and the application type and the application version of the binary attachment data is compared with the application types and application versions of the text strings specified in the policy information. If the application types and the application versions match, then the binary data for the buffered attachment data is compared with the binary data for the specified text strings to determine a partial match.

If S/MIME library module 336 determines that there is not a partial match (“NO at step S618”), then processing proceeds to step S620.

At step S620, the e-mail message, to which the policy information obtained at step S602 is applied, is secured prior to transmission to the policy server.

The e-mail message is secured by signing and/or encrypting the e-mail message. The S/MIME standard defines two types of signing methods. One method is a method for generating a clear-signed message, and the other is a method for generating an opaque-signed message. In the example embodiment, a signAndEnvelope( ) method of the SMIMEMail object is a signing and then encrypting method for a clear-signed encrypted message. A clear-signed message can be read by a message recipient even if the digital signature is invalid. In contrast, an opaque-signed message cannot be read by a recipient if the message's digital signature is invalid. The clear-signed message has an “application/pkcs7-signature” MIME type, whereas the opaque-signed message has an “application/pkcs7-mime” MIME type. As with the opaque-signed message, an encrypted message also has an “application/pkcs7-mime” MIME type.

More precisely, for a signed and then encrypted message, if the message is a clear-signed message, S/MIME library module 336 encrypts the buffered attachment data by using encryption streaming module 408 with a symmetric-key encryption algorithm, such as, for example, Triple DES, an AES algorithm, or the like, and also computes and updates the digest value of the buffered attachment data before sending the encrypted attachment data to each recipient. In particular, the digest value is computed by using digest streaming module 407 to calculate the digest value by using a Cryptographic hash function of the signer module 338. Example Cryptograph hash functions of signer module 338 include, for example, MD5, an SHA-1 algorithm, or the like. In the example embodiment, the Cryptograph hash function is specified in the signer's certificate. Therefore, the buffered attachment data is digested (using the digest algorithm information specified by the signer information) to generate a message digest value at the same time that the buffered portion of the attachment data is sent to the mail server via the output data stream. The digest value is updated as additional portions of the streamed attachment data are received and digested.

More specifically, an encoding method of mail module 337 is used to apply Base 64 transfer encoding to the generated digest value. Mail module 337 generates a Base64 output data stream (i.e., a Base64EncoderStream that wraps an SMTPOutputStream) for streaming attachment data for generating MIME PKCS7 signature data. After generating the Base64 output data stream, mail module 337 passes a pointer to the Base64 output data stream to S/MIME callback handler module 401. S/MIME callback handler module 401 passes the pointer to the Base64 output data stream to digest streaming module 407. Digest streaming module 407 buffers data in the primary buffer memory and calculates the digest value with signing output streaming, and writes the buffered data to the mail server via the Base64 output data stream. Thereafter, processing proceeds to step S621.

In a case where the secondary buffer memory is not empty, then S/MIME library module 336 appends the attachment data in the primary buffer memory to the end of the data in the secondary buffer memory to form aggregated attachment data, digests the aggregated attachment data, and for signed messages that are encrypted, encrypts the aggregated attachment data before sending the aggregated attachment data to each recipient.

In other embodiments, the attachment data is not encrypted. In other embodiments, S/MIME library module 336 digests the encrypted buffered attachment data. In other embodiments, S/MIME library module 336 digests the buffered attachment data.

At step S621, S/MIME library module 336 determines whether all of the attachment data for a current attachment file has been sent. If all attachment data for the current attachment file has not been sent (“NO” at step S621), then processing returns to step S615, where more attachment data for the current attachment file is read.

If all attachment data for the current attachment file has been sent (“YES” at step S621), then at step S622, S/MIME library module 336 determines whether there are other attachment files to be sent. If there are other attachment files to be sent (“YES” at step S622), then processing returns to step S614, where S/MIME library module 336 sends attachment data header attributes for the next attachment data to the mail server via the output data stream, and begins processing of the attachment file for the next attachment data.

If there are no other attachment files to be sent (“NO” at step S622), then at step S623, after streaming module 406 sends all attachment data for all attachment files to the mail server, streaming module 406 passes the generated digest value to S/MIME callback handler module 401. In the ease that the reading of the attachment data from the input data stream is stopped abruptly, the digest value can still be used to generate a valid MIME PKCS7 signature data for the attachment data that has already been read.

In steps S611 to S614, step S620 and step S623, the email message, to which the policy information obtained at step S602 is applied, is sent from the client machine 101 to the recipient via mail server 106.

In more detail, in steps 611 to 614, as discussed above, the message content and attachment header (if any) are sent to mail server 106. In step S620, attachment data is sent to mail server 106.

Then, in step 623, for the signed and then encrypted message, the digest value obtained in step S620 is used to generate the MIME PKCS7 signature data. The recipient information is used to generate MIME PKCS7 encrypted (i.e., enveloped) data for the S/MIME message, and the MIME PKCS7 signature data is first sent to the recipient via the mail server, and then the MIME PKCS7 encrypted data is sent to the recipient via the mail server.

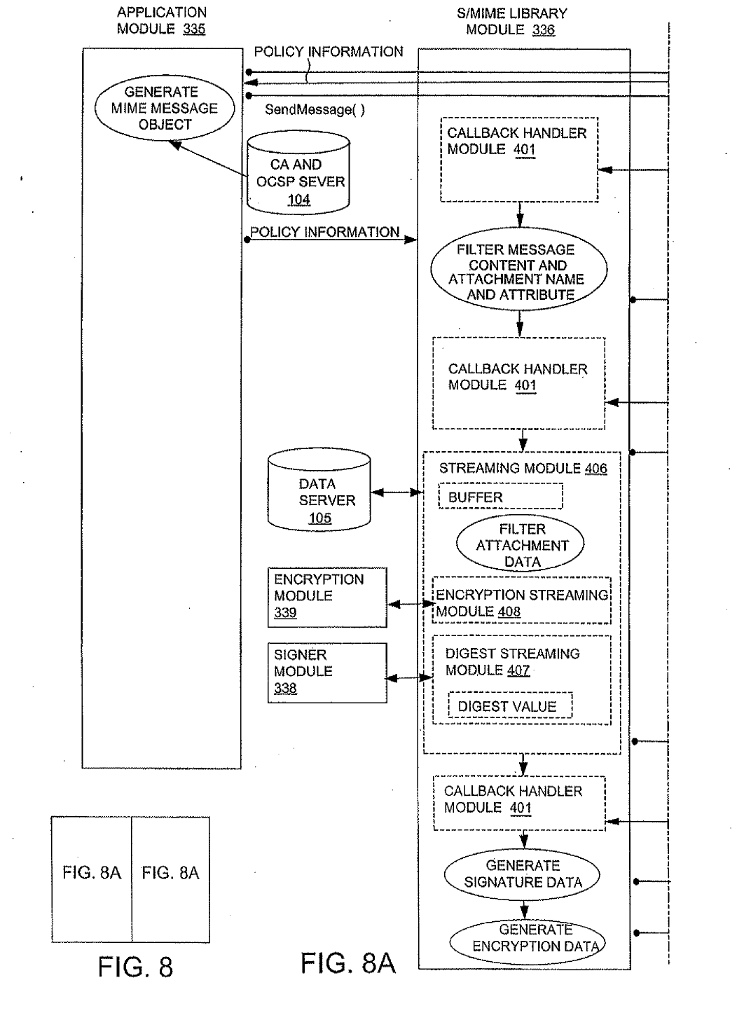

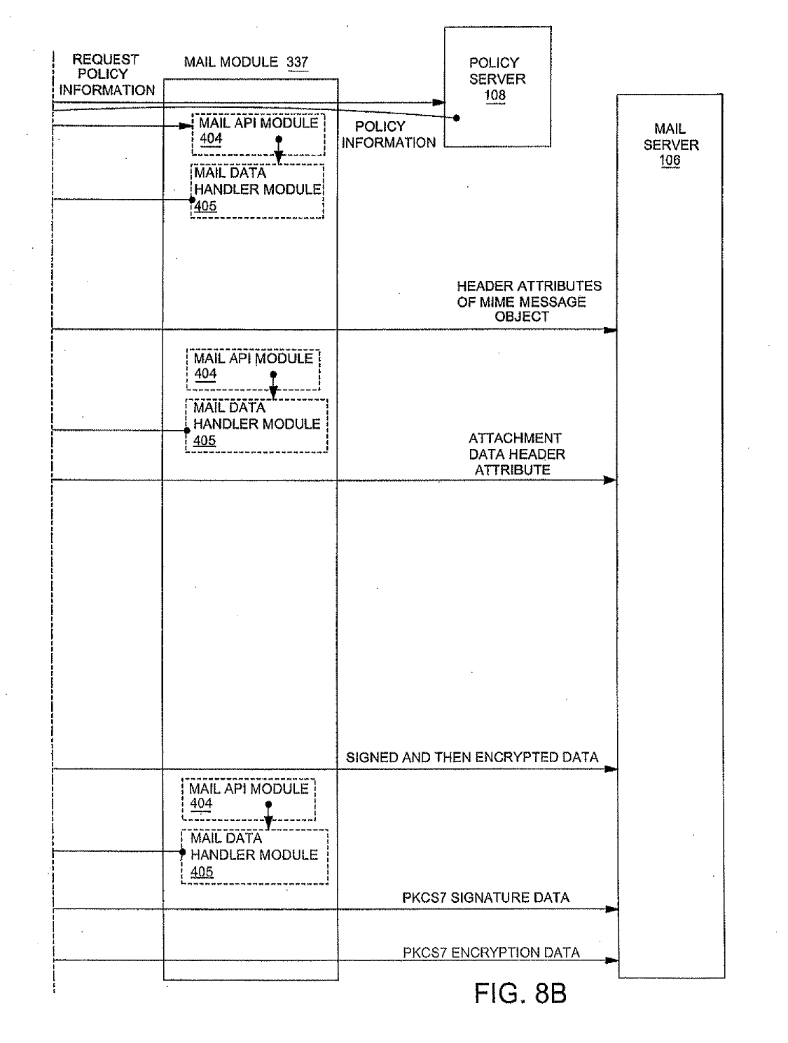

FIG. 8 is a view for explaining a sequence for sending an e-mail message using sending device 101. In particular, FIG. 8 is a view for explaining certain aspects of the sequence of communications described above with respect to FIG. 6. In the example embodiment illustrated in FIG. 8, the data source is a location on data server 105. However, in other embodiments, the data source can be local storage locations on hard disk 345, or addresses of real-time data input devices, such as, for example, a scanner connected to scanner interface 324, or remote locations such as, for example, locations on data server 105.

Initially, S/MIME application module 335 generates the MimeMessage object, as described above with respect to step S601. Before the MimeMessage object is sent, the attachment MimeBodyPart of the MimeMessage object does not contain the actual attachment data, but rather contains the location of attachment files. Additionally, before the MimeMessage object is sent, the MIME PKCS7 signature MimeBodyPart of the MimeMessage object does not contain the actual MIME PKCS7 signature data, but rather contains the signer information which specifies the signer used to generate the MIME PKCS7 signature data.

After the MimeMessage object is generated, S/MIME application module 335 calls the sendMessage( ) method of the SMIMEMail object to send the e-mail message represented by the MimeMessage object, as also described above with respect to step S601. In response to S/MIME application module 335 calling the sendMessage( ) method of the SMIMEMail object, mail API module 404 of mail module 337 generates an output data stream for streaming the e-mail message represented by the MimeMessage object from sending device 101 to a mail server specified by the recipient information (e.g., mail server 106), and connected to sending device 101 via network 107. In the example embodiment, the output data stream wraps a signing output data stream and an encryption output data stream. The output data stream is represented by streaming module 406, the signing output data stream is represented by digest streaming module 407, and the encryption output data stream is represented by encryption streaming module 408, as shown in FIG. 4.

After generating the output data stream represented by streaming module 406, mail API module 404 calls S/MIME callback handler module 401 (which is registered as the callback class for the MimeMessage object, as described above for step S601) via mail data handler module 405 and passes a pointer to the streaming module 406 to S/MIME callback handler module 401. For the signing operation, the output data stream represented by streaming module 406 wraps a signing output data stream, and for the encryption operation, the output data stream wraps an encryption output data stream.

S/MIME library module 336 obtains filtering policy information from policy server 108, via S/MIME application module 335, and performs content filtering for the message content based on the obtained filtering policy, as described above for step S602. S/MIME library module 336 also filters attachment files based on the filename and file extension of attachment files, as described above with respect to steps S607 to S610 and S616 to S622.

S/MIME library module 336 filters attachment data as described above with respect to steps S615 to S619, before encrypting, sending and digesting the buffered attachment data as described above with respect to steps S620 and step S623.

All attachment data specified by the attachment information is sent to the mail server, and streaming module 406 passes the generated digest value to S/MIME callback handler module 401. Mail module 337 generates a Base64 output data stream (i.e., a Base64EncoderStream that wraps an SMTPOutputStream) for streaming, and S/MIME callback handler module 401 receives a pointer to the Base64 output data stream. For the signing operation, the streaming uses digest streaming module 407, which utilizes a Cryptograph hash function for streaming the attachment data of the e-mail message represented by the MimeMessage object. The Cryptographic has function is provided by signer module 338. Likewise, for the encryption operation, the streaming uses encrypting streaming module 408, which utilizes a symmetric-key algorithm for streaming the encryption data. The symmetric-key algorithm is provided by encryption module 339. If both the signing and the encryption operation are applied, then the digest operation is applied first for a sign and then encrypted message, and the encryption operation is applied first for an encrypted and then signed message. In the case that the reading of the attachment data from the input data stream is stopped abruptly, the digest value can still be used to generate a valid MIME PKCS7 signature data for the attachment data that has already been read.

Next, S/MIME callback handler module 401 calls signer module 338 to generate the MIME PKCS7 signature data using the signer specified by the signer information. Also, the encryption module 339 uses the recipient's certificate information to generate MIME PKCS7 encryption data. For the signed and then encrypted case, the MIME PKCS7 encryption data is sent after the MIME PKCS7 signature data. Likewise, for the encrypted and then signed case, the MIME PKCS7 signature data is sent after the MIME PKCS7 encryption data. The MIME PKCS7 signature data and the MIME PKCS7 encryption data are sent via the Base 64 output data stream.

This disclosure has provided a detailed description with respect to particular representative embodiments. It is understood that the scope of the appended claims is not limited to the above-described embodiments and that various changes and modifications may be made without departing from the scope of the claims.

What is claimed is:

1. A method for content filtering of e-mail in a network environment that includes a client machine, a policy server and an e-mail server, the method comprising:
authoring an e-mail message at the client machine;
obtaining filter policy information from the policy server, wherein the filter policy information is obtained by the client machine and defines a filtering policy for filtering of e-mail messages;
applying the filter policy information to the e-mail message, wherein the filter policy information is applied by the client machine to the e-mail message so as to effect the filtering policy;
securing the filtered e-mail message, wherein the filtered e-mail message is secured by the client machine based on a key obtained by the client machine from a key store; and
sending the secure e-mail message to a recipient via the e-mail server.

2. The method according to claim 1, wherein the network architecture further includes a key store, and wherein the client machine secures the filtered e-mail message based on a key obtained by the client machine from the key store.

3. The method according to claim 1, wherein the client machine secures the filtered e-mail message by signing the filtered e-mail message by using a private key of a sender of the e-mail message.

4. The method according to claim 1, wherein the client machine secures the filtered e-mail message by encrypting the filtered e-mail message by using a public key of the recipient.

5. The method according to claim 1, wherein filtering of e-mail messages includes at least one of removing and updating specified message content of e-mail messages.

6. The method according to claim 1, wherein filtering of e-mail messages includes removing specified attachment files from e-mail messages.

7. The method according to claim 1, wherein filtering of e-mail messages includes at least one of removing and updating specified content in attachment files of e-mail messages.

8. The method according to claim 1, wherein filtering of e-mail messages includes blocking an e-mail message, such that the e-mail message is not sent to specified recipients.

9. The method according to claim 1, wherein the policy server and the e-mail server are implemented on a common server machine.

10. The method according to claim 1, wherein the policy server and the e-mail server are implemented on distinctly different machines that communicate over the network.

11. The method according to claim 1, wherein the filtering policy comprises a network-wide filtering policy which is applied by all of plural client machines on the network.

12. The method according to claim 1, wherein the secure e-mail message is sent using an S/MIME (Secure/Multipurpose Internet Mail Extensions) protocol.

13. A module for content filtering of e-mail in a network environment that includes a client machine, a policy server and an e-mail server, the module comprising:
a message module constructed to receive an e-mail message authored at the client machine;
a policy module constructed to obtain filter policy information from the policy server, wherein the filter policy information is obtained by the client machine and defines a filtering policy for filtering of e-mail messages; and
a filtering module constructed to apply the filter policy information to the e-mail message, wherein the filter policy information is applied by the client machine to the e-mail message so as to effect the filtering policy;
wherein the e-mail module is further constructed to secure the filtered e-mail message based on a key obtained by the client machine from a key store, and
wherein the e-mail module is further constructed to send the secure e-mail message to a recipient via the e-mail server.

14. The module according to claim 13, wherein the network architecture further includes a key store, and wherein the client machine secures the filtered e-mail message based on a key obtained by the client machine from the key store.

15. The module according to claim 13, wherein the client machine secures the filtered e-mail message by signing the filtered e-mail message by using a private key of a sender of the e-mail message.

16. The module according to claim 13, wherein the client machine secures the filtered e-mail message by encrypting the filtered e-mail message by using a public key of the recipient.

17. The module according to claim 13, wherein filtering of e-mail messages includes at least one of removing and updating specified message content of e-mail messages.

18. The module according to claim 13, wherein filtering of e-mail messages includes removing specified attachment files from e-mail messages.

19. The module according to claim 13, wherein filtering of e-mail messages includes at least one of removing and updating specified content in attachment files of e-mail messages.

20. The module according to claim 13, wherein filtering of e-mail messages includes blocking an e-mail message, such that the e-mail message is not sent to specified recipients.

21. The module according to claim 13, wherein the policy server and the e-mail server are implemented on a common server machine.

22. The module according to claim 13, wherein the policy server and the e-mail server are implemented on distinctly different machines that communicate over the network.

23. The module according to claim 13, wherein the filtering policy comprises a network-wide filtering policy which is applied by all of plural client machines on the network.

24. The module according to claim 13, wherein the secure e-mail message is sent using an S/MIME (Secure/Multipurpose Internet Mail Extensions) protocol.

25. A client machine, the client machine comprising:
a computer-readable memory constructed to store computer-executable process steps; and
a processor constructed to execute the computer-executable process steps stored in the memory;
wherein the process steps stored in the memory cause the processor to perform a method for content filtering of e-mail in a network environment that includes the client machine, a policy server and an e-mail server, and include computer-executable process steps to:
author an e-mail message at the client machine;
obtain filter policy information from the policy server, wherein the filter policy information is obtained by the client machine and defines a filtering policy for filtering of e-mail messages;
apply the filter policy information to the e-mail message, wherein the filter policy information is applied by the client machine to the e-mail message so as to effect the filtering policy;
secure the filtered e-mail message, wherein the filtered e-mail message is secured by the client machine based on a key obtained by the client machine from a key store; and
send the secure e-mail message to a recipient via the e-mail server.

26. The client machine according to claim 25, wherein the network architecture further includes a key store, and wherein the client machine secures the filtered e-mail message based on a key obtained by the client machine from the key store.

27. The client machine according to claim 25, wherein the client machine secures the filtered e-mail message by signing the filtered e-mail message by using a private key of a sender of the e-mail message.

28. The client machine according to claim 25, wherein the client machine secures the filtered e-mail message by encrypting the filtered e-mail message by using a public key of the recipient.

29. The client machine according to claim 25, wherein filtering of e-mail messages includes at least one of removing and updating specified message content of e-mail messages.

30. The client machine according to claim 25, wherein filtering of e-mail messages includes removing specified attachment files from e-mail messages.

31. The client machine according to claim 25, wherein filtering of e-mail messages includes at least one of removing and updating specified content in attachment files of e-mail messages.

32. The client machine according to claim 25, wherein filtering of e-mail messages includes blocking an e-mail message, such that the e-mail message is not sent to specified recipients.

33. The client machine according to claim 25, wherein the policy server and the e-mail server are implemented on a common server machine.

34. The client machine according to claim 25, wherein the policy server and the e-mail server are implemented on distinctly different machines that communicate over the network.

35. The client machine according to claim 25, wherein the filtering policy comprises a network-wide filtering policy which is applied by all of plural client machines on the network.

36. The client machine according to claim 25, wherein the secure e-mail message is sent using an S/MIME (Secure/Multipurpose Internet Mail Extensions) protocol

37. A computer-readable memory medium on which is stored computer-executable process steps for content filtering of e-mail in a network environment that includes a client machine, a policy server and an e-mail server, said process steps comprising:
authoring an e-mail message at the client machine;
obtaining filter policy information from the policy server, wherein the filter policy information is obtained by the client machine and defines a filtering policy for filtering of e-mail messages;
applying the filter policy information to the e-mail message, wherein the filter policy information is applied by the client machine to the e-mail message so as to effect the filtering policy;
securing the filtered e-mail message, wherein the filtered e-mail message is secured by the client machine based on a key obtained by the client machine from a key store; and
sending the secure e-mail message to a recipient via the e-mail server.

38. The computer-readable memory medium according to claim 37, wherein the network architecture further includes a key store, and wherein the client machine secures the filtered e-mail message based on a key obtained by the client machine from the key store.

39. The computer-readable memory medium according to claim 37, wherein the client machine secures the filtered e-mail message by signing the filtered e-mail message by using a private key of a sender of the e-mail message.

40. The computer-readable memory medium according to claim 37, wherein the client machine secures the filtered e-mail message by encrypting the filtered e-mail message by using a public key of the recipient.

41. The computer-readable memory medium according to claim 37, wherein filtering of e-mail messages includes at least one of removing and updating specified message content of e-mail messages.

42. The computer-readable memory medium according to claim 37, wherein filtering of e-mail messages includes removing specified attachment files from e-mail messages.

43. The computer-readable memory medium according to claim 37, wherein filtering of e-mail messages includes at least one of removing and updating specified content in attachment files of e-mail messages.

44. The computer-readable memory medium according to claim 37, wherein filtering of e-mail messages includes blocking an e-mail message, such that the e-mail message is not sent to specified recipients.

45. The computer-readable memory medium according to claim 37, wherein the policy server and the e-mail server are implemented on a common server machine.

46. The computer-readable memory medium according to claim 37, wherein the policy server and the e-mail server are implemented on distinctly different machines that communicate over the network.

47. The computer-readable memory medium according to claim 37, wherein the filtering policy comprises a network-wide filtering policy which is applied by all of plural client machines on the network.

48. The computer-readable memory medium according to claim 37, wherein the secure e-mail message is sent using an S/MIME (Secure/Multipurpose Internet Mail Extensions) protocol.

49. The method according to claim 1, wherein the client machine secures the filtered e-mail message by signing the filtered e-mail message with S/MIME signature.

50. The method according to claim 1, wherein the client machine secures the filtered e-mail message by encrypting the filtered e-mail message with S/MIME encryption.

51. The module according to claim 13, wherein the client machine secures the filtered e-mail message by signing the filtered e-mail message with S/MIME signature.

52. The module according to claim 13, wherein the client machine secures the filtered e-mail message by encrypting the filtered e-mail message with S/MIME encryption.

53. The client machine according to claim 25, wherein the client machine secures the filtered e-mail message by signing the filtered e-mail message with S/MIME signature.

54. The client machine according to claim 25, wherein the client machine secures the filtered e-mail message by encrypting the filtered e-mail message with S/MIME encryption.

55. The computer-readable memory medium according to claim 37, wherein the client machine secures the filtered e-mail message by signing the filtered e-mail message with S/MIME signature.

56. The computer-readable memory medium according to claim 37, wherein the client machine secures the filtered e-mail message by encrypting the filtered e-mail message with S/MIME encryption.
